(19) United States
(12) Patent Application Publication
(10) Pub. No.: US 2003/0201628 A1
(43) Pub. Date: Oct. 30, 2003

(54) Front passenger air bag pocket baffle

(75) Inventors: Raj. S. Roychoudhury, Bloomfield Hills, MI (US); Hyunsok Pang, Rochester Hills, MI (US); Dhirenkumar Patel, Windsor (CA); David E. Thomas, North Branch, MI (US)

Correspondence Address: BREED TECHNOLOGIES, INC, PATENT DEPARTMENT, 7000 NINETEEN MILE ROAD, STERLING HEIGHTS, MI, 48314

(73) Assignee: Breed Automotive Technologies, Inc.

(21) Appl. No.: 10/387,923

(22) Filed: Mar. 13, 2003

Related U.S. Application Data
(60) Provisional application No. 60/376,038, filed on Apr. 26, 2002.

(51) Int. Cl. B60R 21/24

(52) U.S. Cl. 280/729

(57) ABSTRACT

An air bag module comprising an inflator (350) having at least one exit port located on one side of a body, wherein inflation gas exiting the at least one exit port includes an axial component of flow, which exits the exit port in an axial direction; and an air bag assembly (200) comprising an outer air bag (202) and an inner air bag (300), the inner air bag disposed about the inflator to receive inflation gas before the inflation gas can substantially affect a trajectory of the inflating outer air bag (202), the inflation gas flowing within the inner air bag in at least the axial direction, the inner air bag including a first and second opening (306) to direct inflation gas into the inner bag with components of gas flow exiting the second opening(s) at at least a skewed angle while a portion of the gas flow may optionally flow in a vertical up and down direction, the inner bag also including a third opening (320) disposed near a remote side of the inner bag for directing inflation gas into the outer bag in a direction generally opposite to the axial direction.

This is a regularly filed utility patent application claiming priority of provisional patent application No. 60/376,038, filed Apr. 26, 2002.

### BACKGROUND AND SUMMARY OF THE INVENTION

The present invention generally relates to air bags and more particularly to an air bag that finds use with inflators that have asymmetrically positioned gas exit ports.

FIG. 1 is exemplary of the prior art and shows an air bag 20 having an inflatable cushion portion 22 and a neck portion 24. An inflator 30, of known variety, is inserted within the neck portion and when activated produces inflation gas to inflate the air bag. Inflator 30 includes a plurality of gas exit ports 32. As can be seen, the exit ports are located on one side of the inflator's centerline 34. This type of configuration causes the cushion, during inflation, to skew to one side as the air bag approaches the occupant to be protected. Additionally, because of the initial asymmetric inflation of the air bag, the air bag during the latter moments of inflation will tend to bounce about the centerline and may often seem to wobble or rotate (see arrow 36) about the centerline 34. This bouncing results when the air bag, which was inflating in a skewed direction, becomes fully inflated and reacts against the fixedly positioned inflator.

Reference is briefly made to arrows 36, which diagrammatically illustrate the flow of inflation gas from the inflator 30 into the air bag. It can be shown that with certain types of inflators with asymmetrically placed exit ports the inflation gas actually flows out of these exit ports at an angle and across the body of the inflator. Consequently, the air bag initially skews in a direction that is opposite the placement of the exit ports. In the illustrated example, the exit ports are on the left-hand side of the inflator and the air bag initially inflates to the right-hand side.

The prior art prevents the skewing of the air bag during the initial periods of inflation by enveloping the inflator with a tube-like manifold, such as taught in U.S. Pat. No. 5,340,147, which is incorporated herein by reference. This type of manifold includes a plurality of openings positioned longitudinally across the diffuser, which causes the inflation gas to enter the neck 24 of the air bag in a more uniform manner. While the performance differential provided by the separate manifold is desirable, it does increase the cost and mass of the air bag system.

It is an object of the present invention to provide improved air bag deployment kinematics and air bag module.

Accordingly the invention comprises: an air bag module comprising an air bag assembly comprising: an inner bag secured about the neck of an outer bag, the inner bag comprising a first and second panel, each of which includes a first opening centrally located near the top of the inner bag; the inner bag further including an additional side opening located proximate the top of one of the side areas of the inner bag and located on the same side of the bag as the exit ports of an inflator used to inflate the bag.

Many other objects and purposes of the invention will be clear from the following detailed description of the drawings.

### BRIEF DESCRIPTION OF THE DRAWINGS

FIG. 1 shows an exemplary prior art passenger air bag system.

FIG. 2 is an isometric view of an air bag assembly.

FIG. 3 shows one of the side panels of an outer air bag.

FIG. 4a is a top plan view of an internal bag or sac used in conjunction with the outer air bag of FIG. 2.

FIG. 4b is a side view of the inner bag.

FIG. 5 is an isometric view of the inner bag or sac.

FIG. 6 is an enlarged view showing the connection between the inner and the outer bags.

FIG. 7 is a top plan view of the air bag assembly showing the relation of the inner and the outer air bags.

FIG. 8 is a plan view of the neck portion of the air bag assembly.

FIG. 9 is an isometric view of an exemplary housing.

FIG. 10 diagrammatically shows the housing, air bag assembly and inflator.

### DETAILED DESCRIPTION OF THE DRAWINGS

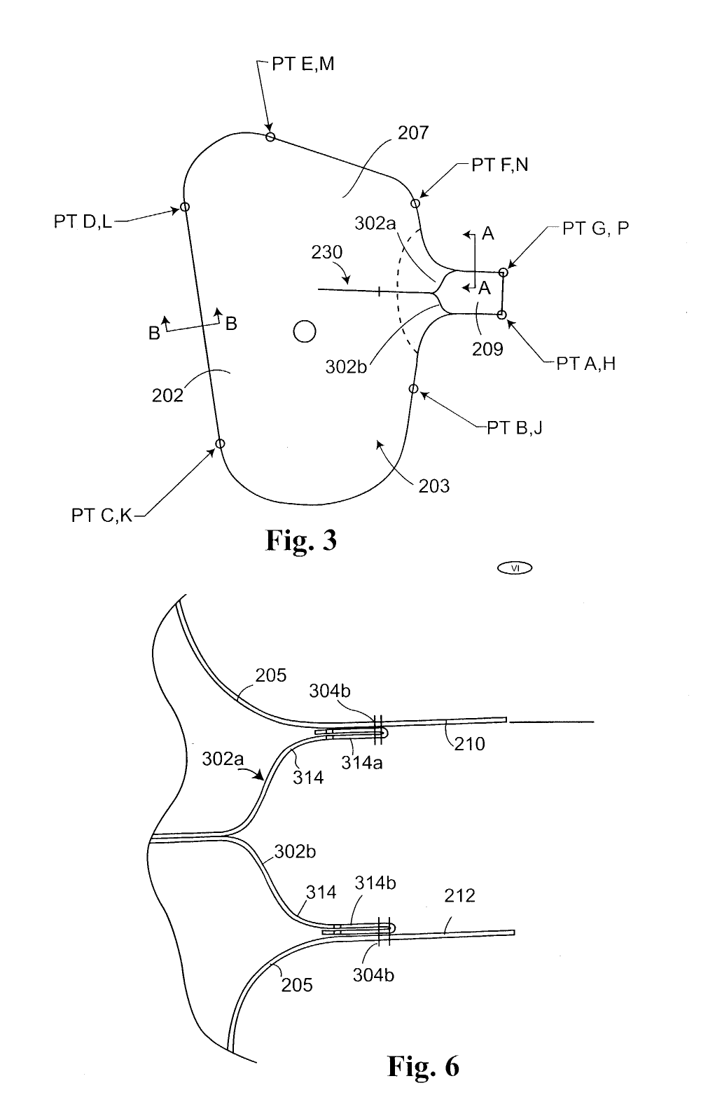

Reference is briefly made to FIGS. 2 and 3, which illustrate various views of an air bag assembly 200. The assembly includes an outer air bag 202 and an inner air bag, pouch or sac 300. The bag 202 can be formed using two side panels 203 and a center, elongated or main panel 205, which forms the top, front (face) and bottom of the outer air bag 202, as well as the top and bottom portions of a neck portion of the outer bag. Other constructions are within the scope of the invention.

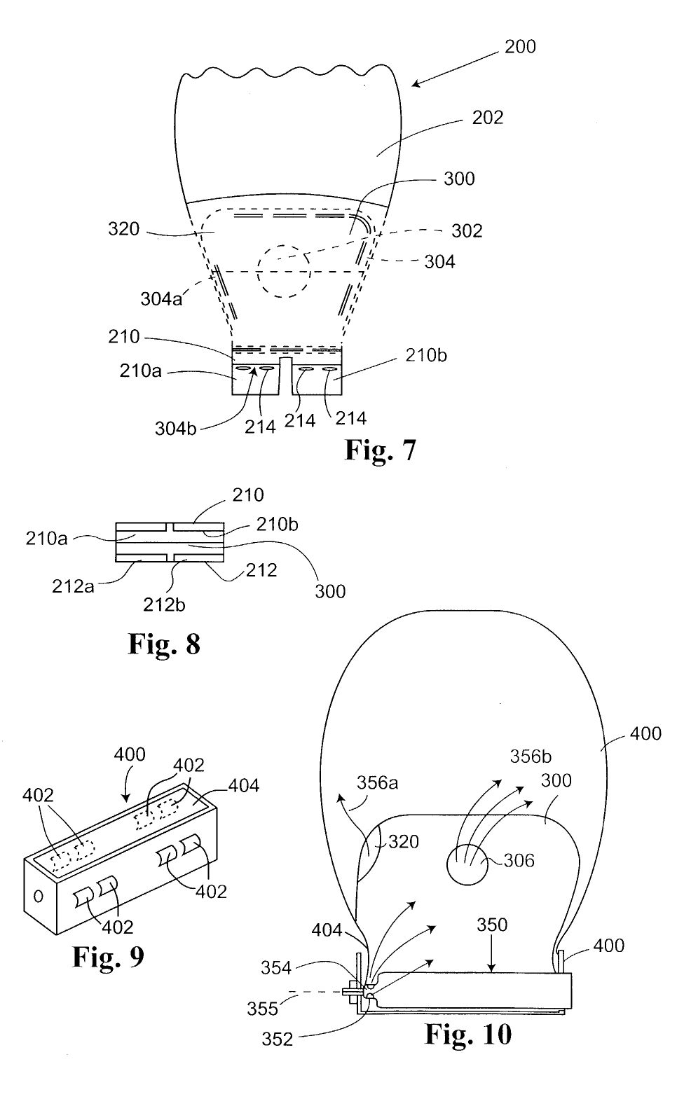

As can be appreciated, the shape of the outer bag can vary. In the illustrated embodiment each side panel 203 includes a large lobe 207 and an elongated portion 209, which forms part of the neck portion of the air bag 202. As can be seen in FIG. 2, the various panels forming the air bag 202 define a cushion portion 211 and an open-ended neck portion 213. The neck portion 213 is generally rectangular in cross-section (other shapes are within the scope of the invention) and includes sides formed by the elongated portion 209 of each side panel and a top 210 and a bottom 212 (which may also be viewed as top and bottom flaps) formed by portions of the main panel 205 (see FIG. 6). Each of the top and the bottom are divided into sections or flaps, such as 210a and 210b, 212a and 212b (see FIG. 8). Each of the various sections includes a plurality of slots 214 (see FIGS. 2 and 7). As will be shown below, the neck portion 213 of the air bag 202 is fitted about the periphery of a mating rectangular-shaped housing and the slots 214 secured to tabs formed on the housing, thereby securing the neck of the air bag about the housing.

FIGS. 9 and 10 show an exemplary housing 400 with a plurality of tabs 402, which are received within respective slots or openings 214.

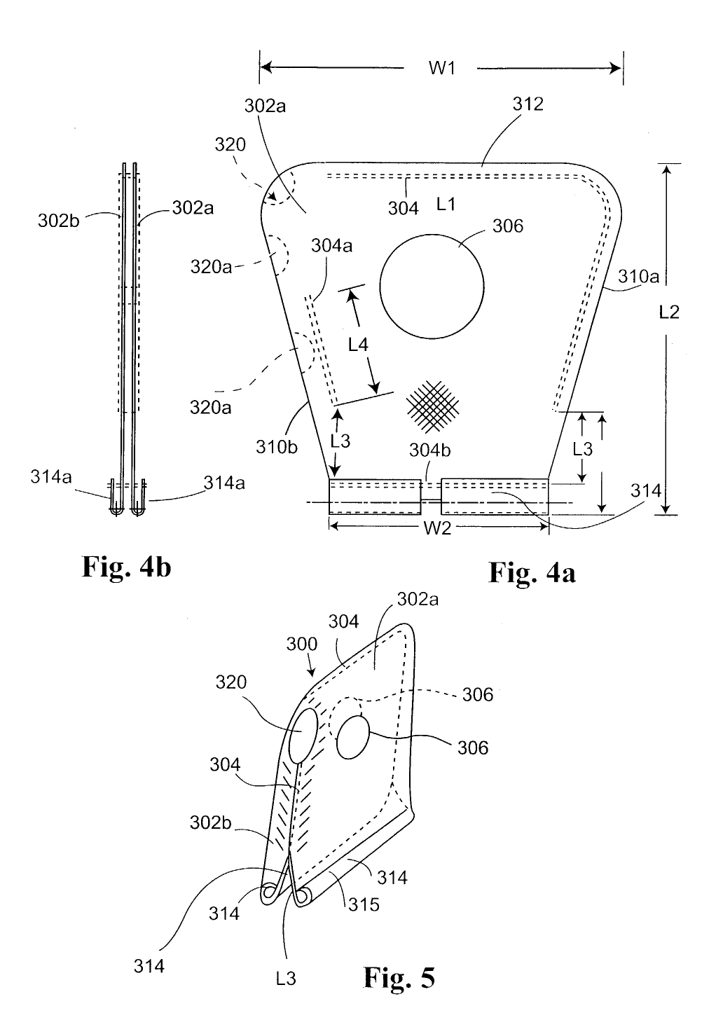

Reference is made to FIGS. 4a, 4b, 5 and 6, which illustrate the details of an inner bag or sac 300. The bag or sac 300 may be constructed of one or more layers or panels of material that are sewn, or otherwise joined, together to form the sac. In the present embodiment, the bag 300 is formed of two generally identical panels of material 302a and 302b that are sewn together along one or more sew lines 304, 304a and 304b. Both of the panels 302a and 302b include an opposed opening 306 having a diameter D. Opening 306 is offset from the top 312 of the bag by a dimension L1. These openings 306 facilitate the flow of inflation gas from the inflator into the center of the outer bag 202 (which may flow vertically up and down) while permitting skewed inflation gas flow from the inflator through opening 306 into the outer bag.

The inner bag 300 is somewhat trapezoidal in shape but could also be rectangular or triangular or for that matter any shape that can accommodate openings such as 306 and openings along a side of the bag such as the compensating opening or openings 320 (some of which are shown in phantom line). As can be seen, the sides 310a and 310b of each of the panels are angled relative to the top 312 and bottom 314 of the panels. The length of each side 310a and b is designated by L2. As can be seen, one of the sew seams extends about the top 312 through side 310a, leaving an unsewn dimension designated as L3 near the bottom 314. As can be seen in FIG. 6, the unsewn portions of the sides 310a and b, when installed within the bag 202, permit the bottoms of the panels 302a and 302b to be separated a sufficient amount so that these bottoms can be sewn to the top 210 and bottom 212 portions of the neck 213 of the outer air bag 202.

The sew seam 304a extends a distance L4 along side 310b of the panels. The seam 304a begins at a dimension L3 from the bottom 314 of the panel to provide the construction shown in FIGS. 4a, 4b and 5. The seam 304a terminates well below the top 312 of the panels, thereby creating an opening 320 along the side of the inner bag. The single compensating opening 320 can be replaced with a plurality of openings 320a (shown in phantom line) to permit gas to escape along the side of the inner bag to compensate and balance the skewed flow through openings 306. As can be seen, the opening 320 is generally opposite to the direction to which the air bag such as 20 tends to initially inflate in a skewed direction. As can be appreciated, the inflation gas exiting opening (or openings) 320 into the outer air bag 202 will push the outer air bag in a direction opposite to the skew direction of inflation.

Reference is again made to FIG. 4b and to the bottom 314 of each panel 302a and 302b. The remote ends of these panels at each bottom are each folded over into a respective flap 314a and 314b to reinforce each of the panels 302a and 302b. The bottoms 314 are sewn to the outer air bag through these reinforcing flaps.

FIG. 6 is an enlarged view showing each of the bottom portions 314 of each panel 302a,b of the inner bag sewn to the main panel 205 of the outer bag along seam 304b. Prior to sewing of the inner to the outer bag the inner bag 300 is placed within the outer air bag 202.

Prior to activation, both air bags are maintained in a compact, folded orientation generally positioned upon the open mouth or top 404 of housing 400. Upon activation of the inflator 350, inflation gas will flow out of one or more of the exit ports 352, which are positioned at or near end 354 of the inflator. The axis of the inflator is shown by numeral 355. The flow characteristics of the inflator 350 are such that the inflation gas flows across the body of the inflator (parallel to the axis 355 of the inflator). If not corrected the outer air bag would inflate in a skewed direction following the inflation gas flow. The inflation gas designated by arrow 356b flows into the interior portions of air bag 202 through the two circular openings 306 in each of the panels 302a and 302b and through the opening (or openings) 320 (see arrows 356a), which as mentioned is situated generally opposite the flow direction of the inflation gas.

As the inflation gas inflates the inner bag, the inflation gas flows out the opening 320. This mass of gas exiting the opening 320 pushes against an adjacent wall of the outer air bag 202 in a direction opposite to the skewed inflation gas flow, which originates at the inflator 350 and some portion of which exits openings 306. The opposite gas flow stream exiting the side opening(s) 320 compensates for the skewed flow exiting the more central openings 306. The air bag 202 now will stay generally aligned with its centerline.

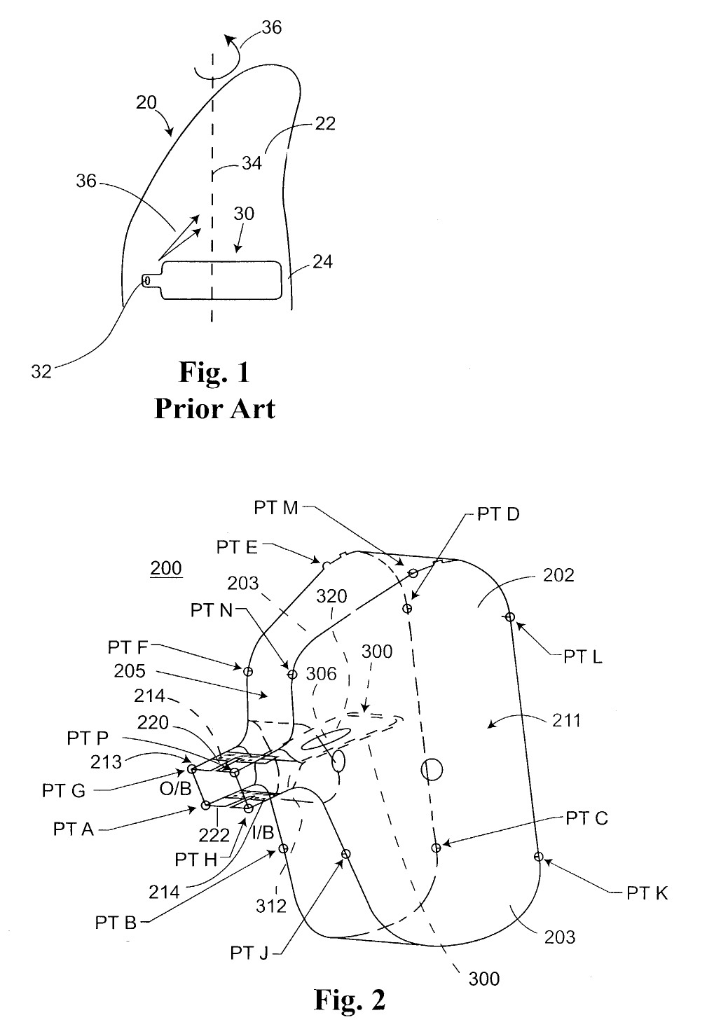

Applicant has conducted comparison tests showing the performance of an air bag module utilizing the same housing 400 and inflator 350. In one set of tests the air bag assembly 200 was used while in other tests only the outer air bag 202 was used, that is, the inner bag was eliminated. Those tests conducted without the inner bag 300 displayed the characteristic asymmetrical inflation of air bag 202 accompanied by the erratic motion of the fully inflated air bag as discussed in relation to FIG. 1. Surprisingly, the performance of the air bag module with the inner bag 300 caused the air bag 200 to inflate symmetrically and displayed considerable stability relative to the vertical plane through the centerline or axis of the air bag.

In the preferred embodiment of the invention, the width W1 of the air bag was approximately 300 mm, width W2: 220 mm, length L2: 312 mm, length L3: approximately 92 mm, length L4: 130 mm and the diameter of the openings 306: approximately 100 mm. The unstitched length of opening 320 was about 120 mm. The volume of the outer air bag was about 130 L. The volume of the inner bag can vary between 2-3 L.

Many changes and modifications in the above-described embodiment of the invention can, of course, be carried out without departing from the scope thereof. Accordingly, that scope is intended to be limited only by the scope of the appended claims.

1. An air bag module comprising an air bag assembly (200) comprising:
an inner bag (300) secured about the neck (204) of an outer bag (200), the inner bag comprising a first and second panel, each of which includes a first opening centrally located near the top of the inner bag;
the inner bag further including an additional side opening located proximate the top of one of the side areas of the inner bag and located on the same side of the bag as the exit ports of an inflator used to inflate the bag.

2. The air bag module as defined in claim 1 wherein each of the side areas of the inner bag is open generally at the neck (315) of the inner bag.

3. An air bag module comprising
an inflator (350) having at least one exit port located on one side of a body, wherein inflation gas exiting the at least one exit port includes an axial component of flow, which exits the exit port in an axial direction;
an air bag assembly (200) comprising an outer air bag (202) and an inner air bag (300), the inner air bag disposed about the inflator to receive inflation gas before the inflation gas can substantially affect a trajectory of the inflating outer air bag (202), the inflation gas flowing within the inner air bag in at least the axial direction, the inner air bag including a first and second opening (306) to direct inflation gas into the outer bag with components of gas flow exiting the second opening(s) at at least a skewed angle while a portion of the gas flow may optionally flow in a vertical up and down direction, the inner bag also including a third opening (320) disposed near a remote side of the inner bag for directing inflation gas into the outer bag in a direction generally opposite to the axial direction.

4. An air bag module comprising
an inflator (350) having at least one exit port located on one side of a body, wherein inflation gas exiting the at least one exit port includes an axial component of flow, which exits the exit port in an axial direction;
an air bag assembly (200) which is configured to inflate along a first axis, the assembly comprising an outer air bag (202) and an inner air bag (300), the inner air bag disposed about the inflator to receive inflation gas before the inflation gas can substantially affect a trajectory of the inflating outer air bag (202), the inflation gas flowing within the inner air bag in at least the axial direction, which is generally perpendicular to the first axis, the inner air bag including a first and a second opening (306), each opening oppositely facing and oriented along a second axis generally perpendicular to the first axis and to the axial direction, the first and the second openings (306) configured to direct inflation gas into the outer bag with components of gas flow exiting the second opening(s) at at least a skewed angle while a portion of the gas flow exits the first and second openings oppositely along the second axis the inner bag also including a third opening (320) disposed along a side of the inner bag for directing inflation gas into the outer bag where the gas exiting the third opening includes at least a component of flow in a direction generally opposite to the axial direction.
